(19) United States
(12) Patent Application Publication
(10) Pub. No.: US 2026/0166956 A1
(43) Pub. Date: Jun. 18, 2026

(54) HEAT PUMP SYSTEM FOR VEHICLE

(71) Applicants: Hyundai Motor Company, Seoul (KR); Kia Corporation, Seoul (KR)

(72) Inventors: Chul Min Kim, Hwaseong-si (KR); Dongseok Oh, Hwaseong-si (KR); Gee Young Shin, Hwaseong-si (KR); Kilwoo Lee, Hwaseong-si (KR); Ji Min Park, Hwaseong-si (KR); Seong-Bin Jeong, Hwaseong-si (KR); Hae Ryong Park, Hwaseong-si (KR); Eun Hye Kim, Hwaseong-si (KR); Sangwon Shin, Hwaseong-si (KR); Jeeyong Paik, Hwaseong-si (KR); Yong Woong Cha, Hwaseong-si (KR); Soo Yong Park, Hwaseong-si (KR)

(21) Appl. No.: 19/248,690

(22) Filed: Jun. 25, 2025

(30) Foreign Application Priority Data
Dec. 13, 2024 (KR) 10-2024-0185639

(51) Int. Cl. B60H 1/00; B60H 1/32

(52) U.S. Cl. CPC B60H 1/00885; B60H 1/00278; B60H 1/3228

(57) ABSTRACT

A heat pump system for a vehicle may be capable of streamlining the entire system and reducing the manufacturing cost and weight by controlling the flowing movement of the coolant by using a single valve depending on at least one mode for adjusting the temperature of the vehicle interior and for adjusting the temperature of the battery, such as in an extended range electric vehicle (EREV) having an engine for charging a battery.

### CROSS-REFERENCE TO RELATED APPLICATIONS

This application claims priority to and the benefit of Korean Patent Application No. 10-2024-0185639 filed with the Korean Intellectual Property Office on Dec. 13, 2024, the entire contents of which is incorporated herein by reference.

### TECHNICAL FIELD

The present disclosure relates to a heat pump system for a vehicle.

### BACKGROUND

In general, improving fuel efficiency of vehicles is a key technology that will determine the survival of the future automobile industry. Accordingly, major automobile manufacturers are putting all their efforts into researching for improving the fuel efficiency of their vehicles to meet the demands of the times, such as environmental and fuel efficiency regulations.

Recently, in accordance with a continuous increase in interest in energy efficiency and an environmental pollution problem, the development of an environment-friendly vehicle capable of substantially substituting for an internal combustion engine vehicle is studied, and the environment-friendly vehicle can be classified into an electric vehicle driven using a fuel cell or electricity as a power source and a hybrid vehicle driven using an engine and a battery.

An electric vehicle (hereinafter referred to as “EV”) includes at least one high-voltage battery configured to supply power and enable movement.

Such a battery discharges over time or when used, and requires charging. Accordingly, a typical EV may charge the battery by physically connecting to an external power supply by using a charging cable.

Recently, extended range electric vehicles (EREVs) that use a motor for driving and an engine only for charging to extend the driving distance are on the rise.

The EREV can be an electric vehicle that uses the power of an internal combustion engine to charge a high-voltage battery, but does not transmit the power of the engine to the wheels.

Accordingly, in the EREV, the engine can charge the battery using a motor generator unit (MGU) operated by the power of the engine when the state of charge (SOC) of the battery is low.

Such an EREV may include, not only a cooling apparatus for the engine and the electrical component for adjusting the temperature of the engine and the electrical component by circulating the coolant, but also a heat pump system for adjusting the vehicle interior temperature by circulating the refrigerant.

However, in such a conventional EREV, an engine cooling apparatus, an electrical component cooling apparatus, a battery cooling apparatus, and an air conditioner unit may be configured as separate closed circuits, respectively.

Accordingly, the EREV may have the disadvantage of increasing the size and weight of the cooling module disposed at the front of the vehicle, and complicating the layout of the connecting pipes that supply the refrigerant or the coolant to respective devices in the narrow front space of the vehicle.

In addition, each device and heat pump system must be equipped with a plurality of valves to control the flow of the coolant and the refrigerant by connecting respective connecting pipes, which makes it difficult to control respective valves and increases the manufacturing cost and weight.

In addition, there is a disadvantage in that noise and vibration caused by frequent opening and closing of each valve are transmitted to the vehicle interior, which reduces ride comfort.

Accordingly, there is a need for technology development to control the temperature of the battery together with the temperature of the vehicle interior by utilizing the thermal energy generated when the engine is in operation, while reducing the number of valves applied to each cooling device applied to EREV.

The above information disclosed in this Background section is only for enhancement of understanding of the background of the present disclosure, and therefore it may contain information that does not form the prior art that is already publicly known, available, or in use.

### SUMMARY

The present disclosure relates to a heat pump system for a vehicle, and more particularly, the present disclosure relates to a heat pump system for a vehicle that can heat the vehicle interior by using a high-temperature coolant, and that is applicable to an extended range electric vehicle (EREV) provided with an engine to charge a battery for supplying electrical power the motor.

An embodiment of the present disclosure can provide a heat pump system for a vehicle capable of streamlining the entire system and reducing the manufacturing cost and weight by controlling the flowing movement of the coolant by using a single valve depending on at least one mode for adjusting the temperature of the vehicle interior and for adjusting the temperature of the battery, in an extended range electric vehicle (EREV) applied with an engine for charging a battery.

An embodiment of the present disclosure can provide a heat pump system for a vehicle, capable of adjusting the temperature of the vehicle interior and also efficiently controlling the battery temperature by using the thermal energy generated from the engine.

A heat pump system for a vehicle may include: a control valve configured to control a flowing movement of an interiorly introduced coolant depending on at least one mode for adjusting a temperature of a vehicle interior or for adjusting a temperature of a battery, and in which a plurality of ports are formed; a heat-exchanger including at least one heat dissipating portion configured to heat-exchange introduced coolants with each other; a first line having a first end connected to the control valve to allow the coolant to selectively flow; a second line having a first end connected to the control valve to allow the coolant to selectively flow; a third line having a first end connected to the control valve, having a second end connected to the heat-exchanger to selectively allow the coolant to flow, and on which an electrical component is provided; a fourth line having a first end connected to the control valve to allow the coolant to selectively flow, and on which a chiller is provided; a fifth line having a first end connected to the control valve, and a second end connected to the heat-exchanger, and through which the coolant flows; a sixth line having a first end connected to the control valve to allow the coolant to selectively flow, and on which the battery is provided; a seventh line having a first end connected to the control valve to allow the coolant to selectively flow, and on which a radiator is provided; an eighth line having a first end connected to the control valve to allow the coolant to selectively flow, a ninth line having a first end connected to the control valve, having a second end connected to the heat-exchanger to selectively allow the coolant to flow, and on which a heater core is provided; and a tenth line having a first end connected to the control valve, having a second end connected to the heat-exchanger to selectively allow the coolant to flow, and on which a condenser is provided, where the heater core is connected to an engine through a first connection line through which the coolant flows, where the heat-exchanger is connected to an intercooler through a second connection line through which the coolant flows, and where at least one water pump is provided in the control valve so that the coolant flow through at least one line of the first to the tenth lines.

A second end of the first line may be connected to a second end of the seventh line, a second end of the second line may be connected to the fourth line between the chiller and a second end of the fourth line, the second end of the fourth line and a second end of the eighth line may be respectively connected a second end of the sixth line, and the second end of the seventh line may be connected to the second end of the first line.

The heat pump system may further include an eleventh line having a first end connected to a second end of the first line and a second end of the seventh line, and a second end connected to the tenth line between the condenser and the heat-exchanger.

The heat pump system may further include an air conditioner unit through which a refrigerant circulates, where the air conditioner unit may include a first refrigerant line connecting the air conditioner unit and the condenser so that the refrigerant is supplied to the condenser, an evaporator connected through a second refrigerant line through which the refrigerant flows, and a third refrigerant line connecting the air conditioner unit and the chiller so that the refrigerant is supplied to the chiller.

The at least one mode may include: a first mode for cooling the electrical component by using the coolant cooled in the radiator while cooling the vehicle interior, and in which the engine is not operated; a second mode for cooling the battery by using the coolant heat-exchanged with the refrigerant, while cooling the vehicle interior, and for cooling the intercooler and the electrical component by using the coolant cooled in the radiator, and in which the engine is operated; a third mode for cooling the intercooler, the electrical component, and the battery by using the coolant cooled in the radiator while cooling the vehicle interior and in which the engine is operated; a fourth mode for heating the vehicle interior by using the thermal energy generated from the intercooler and in which the engine is operated; and a fifth mode for heating the vehicle interior by using the thermal energy generated from the engine and in which the engine is operated.

In the first mode, the first line, the third line, the fifth line, and the seventh line may be opened by the control valve, the second line, the fourth line, the sixth line, the eighth line, and the ninth line may be closed by the control valve, a portion of the tenth line connected to a second end of the eleventh line and having the first end connected to the control valve may be opened by the control valve, a remaining tenth line connecting the second end of the eleventh line to the heat-exchanger may be closed, the first connection line and the second connection line may be closed, the first refrigerant line may be opened so that the refrigerant is supplied from the air conditioner unit to the condenser, the second refrigerant line may be opened so that the refrigerant is supplied from the air conditioner unit to the evaporator, and the third refrigerant line may be closed.

In the second mode, the first line, the third line, the fifth line, and the seventh line may be opened by the control valve, the second line, the eighth line, and the ninth line may be closed by the control valve, the fourth line and the sixth line may be opened by the control valve, a portion of the tenth line connected to a second end of the eleventh line and having the first end connected to the control valve may be opened by the control valve, a remaining tenth line connecting the second end of the eleventh line to the heat-exchanger may be closed, the first connection line may be closed, the second connection line connecting the intercooler and the heat-exchanger may be opened, the first refrigerant line may be opened so that the refrigerant is supplied from the air conditioner unit to the condenser, the second refrigerant line may be opened so that the refrigerant is supplied from the air conditioner unit to the evaporator, and the third refrigerant line may be opened, so that the refrigerant is supplied from the air conditioner unit to the chiller.

In the third mode, the first line, the third line, the fifth line, and the seventh line may be opened by the control valve, the second line, the eighth line, and the ninth line may be closed by the control valve, the fourth line and the sixth line may be opened by the control valve, a portion of the tenth line connected to a second end of the eleventh line and having the first end connected to the control valve may be opened by the control valve, a remaining tenth line connecting the second end of the eleventh line to the heat-exchanger may be closed, the first connection line may be closed, the second connection line connecting the intercooler and the heat-exchanger may be opened, the first refrigerant line may be opened so that the refrigerant is supplied from the air conditioner unit to the condenser, the second refrigerant line may be opened so that the refrigerant is supplied from the air conditioner unit to the evaporator, and the third refrigerant line may be closed.

In the fourth mode, the first line, the third line, the fifth line, and the seventh line may be opened by the control valve, the second line and the fourth line may be opened by the control valve, the sixth line and the eighth line may be closed by the control valve, the ninth line and the tenth line may be opened by the control valve, the eleventh line may be closed, the first connection line may be closed, and the second connection line connecting the intercooler and the heat-exchanger may be opened.

When the thermal energy generated from the intercooler is not sufficient in the fourth mode, the first refrigerant line may be opened so that the refrigerant is supplied from the air conditioner unit to the condenser, the second refrigerant line may be closed, and the third refrigerant line may be opened, so that the refrigerant is supplied from the air conditioner unit to the chiller.

In the fifth mode, the first line, the third line, the fifth line, and the seventh line may be opened by the control valve, the second line, the fourth line, the sixth line, the eighth line, the ninth line, and the tenth line may be closed by the control valve, the eleventh line may be closed, the first connection line may be opened so that the coolant is supplied from the engine to the heater core, the second connection line connecting the intercooler and the heat-exchanger may be opened, and the first refrigerant line, the second refrigerant line, and the third refrigerant line may be closed.

The control valve may include a first port connected to a first end of the first line, a second port connected to a first end of the second line, a third port connected to a first end of the third line, and a fourth port connected to a first end of the fourth line.

The control valve may include a fifth port connected to a first end of the fifth line, a sixth port connected to a first end of the sixth line, a seventh port connected to a first end of the seventh line, an eighth port connected to a first end of the eighth line, a ninth port connected to a first end of the ninth line, and a tenth port connected to a first end of the tenth line.

The at least one water pump may include a first water pump provided on the fifth port, a second water pump provided on the sixth port, and a third water pump provided on the tenth port.

The at least one heat dissipating portion may include a first heat dissipating portion connected to the intercooler through the second connection line, a second heat dissipating portion provided on a first side of the first heat dissipating portion, and connected to the third line and the fifth line, and a third heat dissipating portion provided on a second side of the first heat dissipating portion, and connected to the ninth line and the tenth line.

The coolant introduced from the intercooler into the first heat dissipating portion through a second coolant line respectively may pass through the second heat dissipating portion the third heat dissipating portion, and then may be discharged to the intercooler through the first heat dissipating portion again.

The coolants introduced into the first heat dissipating portion, the second heat dissipating portion, and the third heat dissipating portion may be prevented from mixing with each other.

The coolant introduced from the intercooler into the first heat dissipating portion may be heat-exchanged with at least one of the coolant introduced into the second heat dissipating portion through the fifth line, or the coolant introduced into the third heat dissipating portion through the tenth line.

The heat pump system may further include a coolant heater provided on the sixth line and the ninth line.

The coolant heater may include a first heater provided on the sixth line, and a second heater provided on the ninth line.

As described above, for a heat pump system for a vehicle according to an embodiment of the present disclosure, in an extended range electric vehicle (EREV) applied with an engine for charging a battery, by controlling the flowing movement of the coolant by using a single valve depending on at least one mode for adjusting the temperature of the vehicle interior and for adjusting the temperature of the battery, streamlining of the entire system may be achieved.

According to an embodiment of the present disclosure, by adjusting the temperature of the vehicle interior and efficiently controlling the battery temperature by using the thermal energy generated from the engine and the intercooler, the usage of the electric heater at the time of heating the vehicle interior can be minimized, so that the power consumption amount may be reduced, and the overall marketability may be improved.

According to an embodiment of the present disclosure, the heating efficiency can be improved by selectively using the thermal energy of the engine or intercooler at the time of heating the vehicle interior, and the battery temperature can be efficiently adjusted to obtain the optimal performance of the battery, so that the overall travel distance of the vehicle may be increased.

According to an embodiment of the present disclosure, due to streamlining of the entire system, it can be possible to reduce the overall manufacturing cost and weight, and improve space utilization by minimizing the number of components.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode in a heat pump system for a vehicle according to an embodiment of the present disclosure.

FIG. 3 is an operation diagram according to a second mode in a heat pump system for a vehicle according to an embodiment of the present disclosure.

FIG. 4 is an operation diagram according to a third mode in a heat pump system for a vehicle according to an embodiment of the present disclosure.

FIG. 5 is an operation diagram according to a fourth mode in a heat pump system for a vehicle according to an embodiment of the present disclosure.

FIG. 6 is an operation diagram according to a fifth mode in a heat pump system for a vehicle according to an embodiment of the present disclosure.

### DETAILED DESCRIPTION OF ILLUSTRATIVE EMBODIMENTS

Example embodiments of the present disclosure will hereinafter be described in detail with reference to the accompanying drawings.

Example embodiments disclosed in the present specification and the constructions depicted in the drawings are only examples, and do not necessarily cover the scopes of the present disclosure. Therefore, it can be understood that there may be various equivalents and variations for an embodiment of the present disclosure.

To clarify the present disclosure, parts that are not related to the description can be omitted, and same elements or equivalents can be referred to with same reference numerals throughout the specification.

The size and thickness of each element can be arbitrarily shown in the drawings, but the present disclosure is not necessarily limited thereto, and in the drawings, the thickness of layers, films, panels, regions, etc., can be exaggerated for clarity.

Unless explicitly described to the contrary, the word “comprise” and variations such as “comprises” or “comprising”, can be understood to imply the inclusion of stated elements but not the exclusion of any other elements.

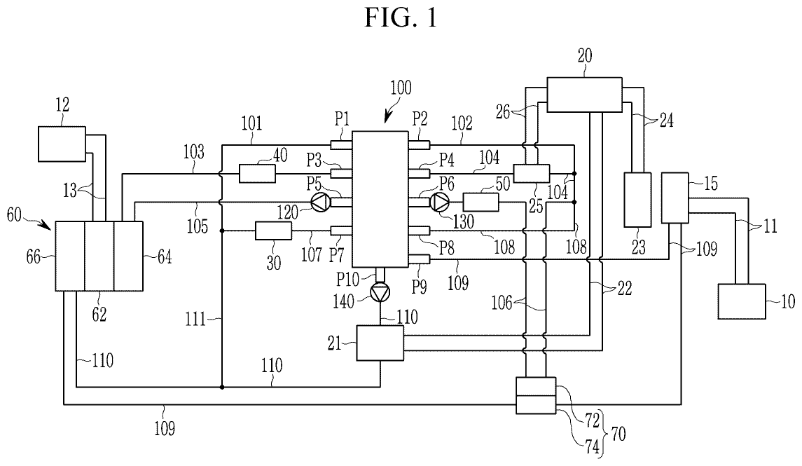

FIG. 1 is a block diagram of a heat pump system for a vehicle according to an embodiment of the present disclosure.

For a heat pump system for a vehicle according to an embodiment of the present disclosure, in an extended range electric vehicle (EREV) applied with an engine 10 for charging a battery 50, a flowing movement of a coolant can be controlled by using a single control valve 100, depending on at least one mode for adjusting a temperature of a vehicle interior and for adjusting a temperature of the battery 50, the manufacturing cost and weight can be reduced while streamlining the entire system.

According to an embodiment of the present disclosure, by selectively using the thermal energy generated from the engine 10 and an intercooler 12, the temperature of the battery 50 may be efficiently controlled as well as adjusting the temperature of the vehicle interior.

Referring to FIG. 1, in a heat pump system according to an embodiment of the present disclosure, the engine 10 through which the coolant circulates, the intercooler 12 provided in the engine 10 and through which the coolant circulates, and an air conditioner unit 20 through which a refrigerant circulates may be interconnected with each other through a heater core 15, a condenser 21, a chiller 25, and a heat-exchanger 60, any of, any combination of, or all of which may be in plural or may include plural components thereof.

The heater core 15 may be selectively connected to the engine 10 through a first connection line 11 through which the coolant flows.

The heat-exchanger 60 may be selectively connected to the intercooler 12 through a second connection line 13 through which the coolant flows.

Although the intercooler 12 may be mounted in the engine 10, to illustrate the connection structure of components briefly and clearly, the drawings illustrates that the engine 10 and the intercooler 12 are disposed at locations apart from each other.

In an embodiment of the present disclosure, the air conditioner unit 20 may further include a first refrigerant line 22, an evaporator 23, a second refrigerant line 24, and a third refrigerant line 26.

The first refrigerant line 22 may connect the air conditioner unit 20 and the condenser 21 so that the refrigerant discharged from the compressor included in the air conditioner unit 20 can be supplied.

The evaporator 23 may be connected to the air conditioner unit 20 through the second refrigerant line 24 through which the refrigerant flows, so that the refrigerant discharged from the expansion valve included in the air conditioner unit 20 can be supplied.

The evaporator 23 may be provided inside a heating, ventilation, and air-conditioning (HVAC) module (not shown) together with the heater core 15, for example.

Accordingly, a high-temperature coolant supplied to the heater core 15 may increase the temperature of the air passing through the heater core 15. That is, the air introduced into the HVAC module may be converted into a high-temperature state while passing through the heater core 15 and then introduced into the vehicle interior, thereby implementing heating of the vehicle interior.

The evaporator 23 may evaporate the refrigerant through heat-exchange with the air introduced into the HVAC module. The air can pass through the evaporator 23 supplied with the refrigerant and may be cooled while passing through the evaporator 23.

That is, the air passing through the evaporator 23 supplied with the refrigerant may be cooled while passing through the evaporator 23 by a low-temperature refrigerant supplied to the evaporator 23. The cooled air may be introduced into the vehicle interior, thereby cooling the vehicle interior.

The third refrigerant line 26 may connect the air conditioner unit 20 and the chiller 25 so that the expanded or unexpanded refrigerant can be supplied from the air conditioner unit 20.

A heat pump system according to an embodiment of the present disclosure may further include the heat-exchanger 60, the control valve 100, a first line 101, a second line 102, a third line 103, a fourth line 104, a fifth line 105, a sixth line 106, a seventh line 107, an eighth line 108, a ninth line 109, a tenth line 110, and an eleventh line 111, any of, any combination of, or all of which may be in plural or may include plural components thereof.

The heat-exchanger 60 may include at least one heat dissipating portion configured to heat-exchange the introduced coolants with each other.

The control valve 100 may control the flowing movement of the interiorly introduced coolant depending on at least one mode for adjusting the temperature of the vehicle interior or for adjusting the temperature of the battery 50, and may be formed with a plurality of ports.

A detailed configuration of the at least one heat dissipating portion and the plurality of ports will be described in detail hereinbelow.

In an embodiment of the present disclosure, a first end of the first line 101 may be connected to the control valve 100 to selectively allow the coolant to flow.

A first end of the second line 102 may be connected to the control valve 100 to selectively allow the coolant to flow.

A first end of the third line 103 may be connected to the control valve 100. A second end of the third line 103 may be connected to the heat-exchanger 60 to selectively allow the coolant to flow.

An electrical component 40 may be provided on the third line 103. The electrical component 40 may include an electrical power control unit (EPCU), or an inverter, or an on-board charger (OBC), or an autonomous driving controller, or the like, for example.

The electrical component 40 configured as such may be provided on the third line 103 and cooled by a water-cooled manner.

A first end of the fourth line 104 may be connected to the control valve 100 to selectively allow the coolant to flow. The chiller 25 may be provided on the fourth line 104.

The chiller 25 may heat-exchange the coolant flowing through the fourth line 104 with the refrigerant supplied from the air conditioner unit 20 through the third refrigerant line 26.

The chiller 25 configured as such may be a water-cooled heat-exchanger into which the coolant can be introduced through the fourth line 104.

In an embodiment of the present disclosure, a first end of the fifth line 105 may be connected to the control valve 100. A second end of the fifth line 105 may be connected to the heat-exchanger 60 to allow the coolant to flow.

A first end of the sixth line 106 may be connected to the control valve 100 to selectively allow the coolant to flow. The battery 50 may be provided on the sixth line 106.

Accordingly, the battery 50 may be provided on the sixth line 106 and cooled/heated by a water-cooled/heated manner.

In an embodiment of the present disclosure, a first end of the seventh line 107 may be connected to the control valve 100 to selectively allow the coolant to flow. A radiator 30 may be provided on the seventh line 107.

The radiator 30 may be disposed at the front of the vehicle. A cooling fan (not shown) may be provided on a downstream side of the radiator 30. Accordingly, the radiator 30 may cool the coolant through an operation of the cooling fan and heat-exchange with an ambient air.

A first end of the eighth line 108 may be connected to the control valve 100 to selectively allow the coolant to flow.

A first end of the ninth line 109 may be connected to the control valve 100. A second end of the ninth line 109 may be connected to the heat-exchanger 60 to selectively allow the coolant to flow.

The heater core 15 may be provided on the ninth line 109 configured as such.

Accordingly, when the vehicle interior is to be heated, the high-temperature coolant may be introduced into the heater core 15 from the engine 10 through the first connection line 11, and/or the high-temperature coolant may be introduced thereinto through the ninth line 109.

In an embodiment of the present disclosure, a first end of the tenth line 110 may be connected to the control valve 100. A second end of the tenth line 110 may be connected to the heat-exchanger 60 to selectively allow the coolant to flow. The condenser 21 may be provided on the tenth line 110 configured as such.

Accordingly, the condenser 21 may condense the refrigerant, and at the same time, increase a temperature of the coolant, while heat-exchanging the refrigerant supplied from the air conditioner unit 20 through the first refrigerant line 22 with the coolant supplied through the tenth line 110.

A first end of the eleventh line 111 may be connected to a second end of the first line 101 and a second end of the seventh line 107. A second end of the eleventh line 111 may be connected to the tenth line 110 between the condenser 21 and the heat-exchanger 60.

The second end of the first line 101 may be connected to the second end of the seventh line 107.

A second end of the second line 102 may be connected to the fourth line 104 between the chiller 25 and a second end of the fourth line 104.

The second end of the fourth line 104 and a second end of the eighth line 108 may be respectively connected to a second end of the sixth line 106.

The second end of the seventh line 107 may be connected to the second end of the first line 101.

The control valve 100 may include a first port P1, a second port P2, a third port P3, a fourth port P4, a fifth port P5, a sixth port P6, a seventh port P7, an eighth port P8, a ninth port P9, and a tenth port P10, any of, any combination of, or all of which may be in plural or may include plural components thereof.

The first end of the first line 101 may be connected to the first port P1. The first end of the second line 102 may be connected to the second port P2. The first end of the third line 103 may be connected to the third port P3.

The first end of the fourth line 104 may be connected to the fourth port P4. The first end of the fifth line 105 may be connected to the fifth port P5. The first end of the sixth line 106 may be connected to the sixth port P6.

The first end of the seventh line 107 may be connected to the seventh port P7. The first end of the eighth line 108 may be connected to the eighth port P8. The first end of the ninth line 109 may be connected to the ninth port P9.

The first end of the tenth line 110 may be connected to the tenth port P10.

At least one water pump may be provided in the control valve 100, to provide coolant flow through at least one line of the first to the tenth lines 101, 102, 103, 104, 105, 106, 107, 108, 109, and 110.

In an embodiment of the present disclosure, the at least one water pump may include a first water pump 120 provided on the fifth port P5, a second water pump 130 provided on the sixth port P6, and a third water pump 140 provided on the tenth port P10.

The first, second, and third water pumps 120, 130, and 140 may be electric water pumps.

In an embodiment of the present disclosure, at least one heat dissipating portion provided in the heat-exchanger 60 may include a first heat dissipating portion 62, a second heat dissipating portion 64, and a third heat dissipating portion 66.

The first heat dissipating portion 62 may be connected to the intercooler 12 through the second connection line 13. Such a first heat dissipating portion may be disposed at a center of the heat-exchanger 60.

The second heat dissipating portion 64 may be provided on a first side of the first heat dissipating portion 62, and may be respectively connected to the third line 103 and the fifth line 105.

The third heat dissipating portion 66 may be provided on a second side of the first heat dissipating portion 62, and may be connected to the ninth line 109 and the tenth line 110.

That is, the second heat dissipating portion 64 and the third heat dissipating portion 66 may be disposed on both sides of the first heat dissipating portion 62, respectively, interposing the first heat dissipating portion 62.

The coolant introduced from the intercooler 12 into the first heat dissipating portion 62 through the second connection line 13 may respectively pass through the second heat dissipating portion 64 and the third heat dissipating portion 66, and may be then discharged to the intercooler 12 through the first heat dissipating portion 62 again.

The coolant respectively introduced into the first heat dissipating portion 62, the second heat dissipating portion 64, and the third heat dissipating portion 66 may be prevented from being mixed with each other.

That is, the coolant introduced from the intercooler 12 into the first heat dissipating portion 62 may be heat-exchanged with at least one of the coolant introduced into the second heat dissipating portion 64 through the fifth line 105, or the coolant introduced into the third heat dissipating portion 66 through the tenth line 110.

In more detail, the coolant introduced into the second heat dissipating portion 64 through the fifth line 105 may only flow in the second heat dissipating portion 64. The coolant introduced into the third heat dissipating portion 66 through the tenth line 110 may only flow in the third heat dissipating portion 66.

Accordingly, the coolant introduced from the intercooler 12 into the first heat dissipating portion 62 through the second connection line 13 may be heat-exchanged with the coolant introduced into one of the second heat dissipating portion 64 and the third heat dissipating portion 66.

The heat-exchanger configured as such may be configured as a plate-type heat-exchanger in which a plurality of plates can be stacked so as to form a plurality of fluid lines through which the coolant flows respectively.

The heat pump system may further include a coolant heater 70 provided on the sixth line 106 and the ninth line 109.

The coolant heater 70 may include a first heater 72 provided on the sixth line 106 and a second heater 74 provided on the ninth line 109.

The first heater 72 may selectively heat the coolant so that the temperature of the coolant introduced through the sixth line 106 is increased. The second heater 74 may selectively heat the coolant so that the temperature of the coolant introduced through the ninth line 109 is increased.

The first heater 72 and the second heater 74 may be integrally formed. The coolants passing through the first heater 72 and the second heater 74, respectively, can be not mixed with each other, so that mutual heat transfer therebetween can be prevented.

In the heat pump system configured as such, the flowing movement of the coolant may be controlled by the control valve 100 depending on the at least one mode for adjusting the temperature of the vehicle interior or for adjusting the temperature of the battery 50.

The at least one mode may include a first mode, a second mode, a third mode, a fourth mode, and a fifth mode, for example.

In the first mode, the engine 10 may not be operated, and the electrical component 40 may be cooled by using the coolant cooled in the radiator 30, while cooling the vehicle interior.

In the second mode, the engine 10 may be operated, the battery 50 may be cooled by using the coolant heat-exchanged with the refrigerant while cooling the vehicle interior, and the intercooler 12 and the electrical component 40 may be cooled by using the coolant cooled in the radiator 30.

In the third mode, the engine 10 may be operated, and the intercooler 12, the electrical component 40, and the battery 50 may be cooled by using the coolant cooled in the radiator 30, while cooling the vehicle interior.

In the fourth mode, the engine 10 may be operated, and the vehicle interior may be heated by using the thermal energy generated from the intercooler 12.

In the fifth mode, the engine 10 may be operated, and the vehicle interior by using the thermal energy generated from the engine 10 may be heated.

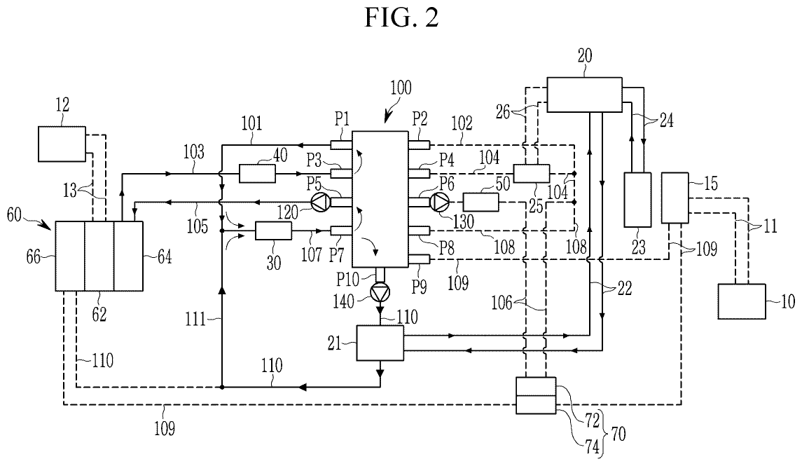

An operation and action of a heat pump system according to an embodiment of the present disclosure configured as such will be described in detail with reference to FIG. 2 to FIG. 6.

An operation in the first mode, for cooling the electrical component 40 by using the coolant cooled in the radiator 30 while cooling the vehicle interior, and in which the engine 10 may not be operated, will be described in detail with reference to FIG. 2.

FIG. 2 is an operation diagram according to the first mode in a heat pump system for a vehicle according to an embodiment of the present disclosure.

Referring to FIG. 2, in the first mode, in the heat pump system, the engine 10 may not be operated, and the electrical component 40 may be cooled by using the coolant cooled in the radiator 30, while cooling the vehicle interior.

To cool the vehicle interior, the air conditioner unit 20 may be operated. Accordingly, the first refrigerant line 22 may be opened so that the refrigerant is supplied from the air conditioner unit 20 to the condenser 21.

The second refrigerant line 24 may be opened so that the refrigerant is supplied from the air conditioner unit 20 to the evaporator 23.

The third refrigerant line 26 may be closed.

In the first mode, the first line 101, the third line 103, the fifth line 105, and the seventh line 107 may be opened by the control valve 100.

Simultaneously, the second line 102, the fourth line 104, the sixth line 106, the eighth line 108, and the ninth line 109 may be closed by the control valve 100.

A portion of the tenth line 110 connected to the second end of the eleventh line 111 and having a first end of the tenth line 110 connected to the control valve 100 may be opened by the control valve 100.

The remaining tenth line 110 connecting the second end of the eleventh line 111 to the heat-exchanger 60 may be closed.

Because the engine 10 is not operated, the first connection line 11 and the second connection line 13 may be closed.

In such a state, the first water pump 120 and the third water pump 140 each may be operated.

Then, the coolant flowing from the fifth port P5 of the control valve 100 along the fifth line 105 by the first water pump 120 may be introduced into the second heat dissipating portion 64 of the heat-exchanger 60.

The coolant having passed through the second heat dissipating portion 64 may pass through the electrical component 40 along the third line 103, and then be introduced into the control valve 100 through the third port P3.

The coolant introduced into the third port P3 may flow along the first line 101 connected to the first port P1 by the control valve 100.

The coolant flowing from the tenth port P10 of the control valve 100 along the opened portion of the tenth line 110 by the third water pump 140 may pass through the condenser 21.

In such mode, the condenser 21 may condense the refrigerant while heat-exchanging the refrigerant supplied through the first refrigerant line 22 with the coolant flowing along the tenth line 110.

The refrigerant condensed in the condenser 21 may be introduced into the air conditioner unit 20 along the first refrigerant line 22.

The coolant having passed through the condenser 21 may flow along the opened portion of the tenth line 110 and the eleventh line 111.

Accordingly, the coolant flowing through the first line 101 may flow to the seventh line 107 together with the coolant flowing through the eleventh line 111.

The coolant flowing through the seventh line 107 may be cooled through heat-exchange with the ambient air while passing through the radiator 30. Thereafter, the coolant cooled in the radiator 30 may be introduced into the control valve 100 through the seventh port P7.

A partial coolant among the coolant introduced into the control valve 100 through the seventh port P7 may flow to the fifth port P5 by the control valve 100.

A remaining coolant among the coolant introduced into the control valve 100 through the seventh port P7 may flow to the tenth port P10 by the control valve 100.

While repeatedly performing such an operation, the coolant cooled in the radiator 30 may cool the electrical component 40, and may condense the refrigerant supplied the condenser 21.

The air conditioner unit 20 may supply the refrigerant condensed in the condenser 21 to the evaporator 23 through the second refrigerant line 24, in an expanded state.

Accordingly, the low-temperature refrigerant may be supplied to the evaporator 23. Then, the air introduced into the HVAC module (not shown) may be cooled by the low-temperature refrigerant introduced into the evaporator 23 while passing through the evaporator 23.

The ambient air cooled while passing through the evaporator 23 may pass through the heater core 15 that is not supplied with the high-temperature coolant, to be introduced into the vehicle interior, thereby smoothly cooling the vehicle interior.

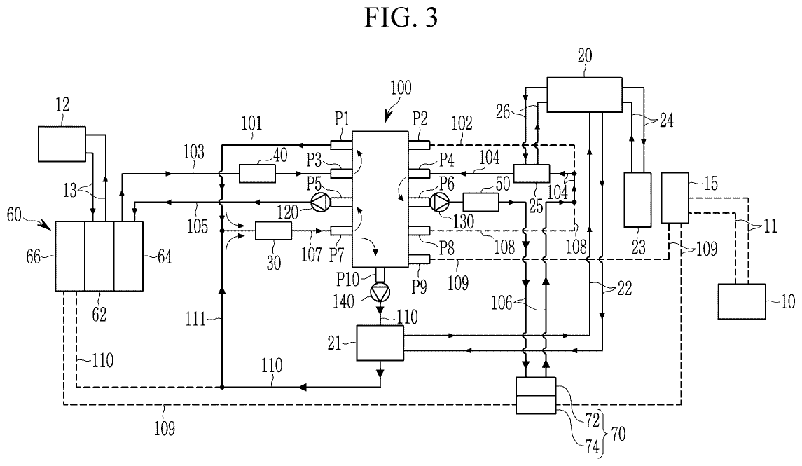

In an embodiment of the present disclosure, an operation in the second mode, for cooling the battery 50 by using the coolant heat-exchanged with the refrigerant, while cooling the vehicle interior, and for cooling the intercooler 12 and the electrical component 40 by using the coolant cooled in the radiator 30, and in which the engine 10 may be operated, will be described in detail with reference to FIG. 3.

FIG. 3 is an operation diagram according to the second mode in a heat pump system for a vehicle according to an embodiment of the present disclosure.

Referring to FIG. 3, in the second mode, in the heat pump system, the engine 10 may be operated, and the battery 50 may be cooled by using the coolant heat-exchanged with the refrigerant, while cooling the vehicle interior, and the intercooler 12 and the electrical component 40 may be cooled by using the coolant cooled in the radiator 30.

To cool the vehicle interior, the air conditioner unit 20 may be operated. Accordingly, the first refrigerant line 22 may be opened so that the refrigerant is supplied from the air conditioner unit 20 to the condenser 21.

The second refrigerant line 24 may be opened so that the refrigerant is supplied from the air conditioner unit 20 to the evaporator 23.

The third refrigerant line 26 may be opened so that the refrigerant is supplied from the air conditioner unit 20 to the chiller 25.

The first line 101, the third line 103, the fifth line 105, and the seventh line 107 may be opened by the control valve 100.

Simultaneously, the second line 102, the eighth line 108, and the ninth line 109 may be closed by the control valve 100.

The fourth line 104 and the sixth line 106 may be opened by the control valve 100.

A portion of the tenth line 110 connected to the second end of the eleventh line 111 and having a first end of the tenth line 110 connected to the control valve 100 may be opened by the control valve 100.

The remaining tenth line 110 connecting the second end of the eleventh line 111 to the heat-exchanger 60 may be closed.

Because the vehicle interior is to be cooled in such mode, the first connection line 11 connecting the engine 10 and the heater core 15 may be closed.

The second connection line 13 connecting the intercooler 12 and the heat-exchanger 60 may be opened. Accordingly, the coolant discharged in the intercooler 12 may be introduced into the first heat dissipating portion 62 of the heat-exchanger 60 along the second connection line 13.

The coolant introduced from the intercooler 12 into the first heat dissipating portion 62 may flow from the first heat dissipating portion 62 to sequentially pass through the third heat dissipating portion 66 and the second heat dissipating portion 64, and then may be discharged again to the intercooler 12.

In such mode, the first water pump 120, the second water pump 130, and the third water pump 140 each may be operated.

Then, the coolant flowing from the fifth port P5 of the control valve 100 along the fifth line 105 by the first water pump 120 may be introduced into the second heat dissipating portion 64 of the heat-exchanger 60.

The coolant having passed through the second heat dissipating portion 64 may pass through the electrical component 40 along the third line 103, and then be introduced into the control valve 100 through the third port P3.

The coolant introduced into the third port P3 may flow along the first line 101 connected to the first port P1 by the control valve 100.

The coolant flowing from the tenth port P10 of the control valve 100 along the opened portion of the tenth line 110 by the third water pump 140 may pass through the condenser 21.

In such mode, the condenser 21 may condense the refrigerant while heat-exchanging the refrigerant supplied through the first refrigerant line 22 with the coolant flowing along the tenth line 110.

The refrigerant condensed in the condenser 21 may be introduced into the air conditioner unit 20 along the first refrigerant line 22.

The coolant having passed through the condenser 21 may flow along the opened portion of the tenth line 110 and the eleventh line 111.

Accordingly, the coolant flowing through the first line 101 may flow to the seventh line 107 together with the coolant flowing through the eleventh line 111.

The coolant flowing through the seventh line 107 may be cooled through heat-exchange with the ambient air while passing through the radiator 30. Thereafter, the coolant cooled in the radiator 30 may be introduced into the control valve 100 through the seventh port P7.

A partial coolant among the coolant introduced into the control valve 100 through the seventh port P7 may flow to the fifth port P5 by the control valve 100.

A remaining coolant among the coolant introduced into the control valve 100 through the seventh port P7 may flow to the tenth port P10 by the control valve 100.

While repeatedly performing such an operation, the coolant cooled in the radiator 30 may cool the electrical component 40, and may condense the refrigerant supplied to the condenser 21.

The coolant cooled in the radiator 30 may cool the coolant supplied from the intercooler 12 through heat-exchange with the coolant introduced from the intercooler 12 into the first heat dissipating portion 62 and passing through the second heat dissipating portion 64, while passing through the second heat dissipating portion 64.

The coolant cooled in the heat-exchanger 60 may be discharged from the first heat dissipating portion 62 to the intercooler 12. Accordingly, the intercooler 12 may be efficiently cooled by the coolant cooled while passing through the heat-exchanger 60.

The coolant flowing from the sixth port P6 of the control valve 100 along the sixth line 106 by the second water pump 130 may pass through the battery 50.

The coolant having passed through the battery 50 may pass through the first heater 72 of the coolant heater 70 along the sixth line 106. The coolant heater 70 is not operated.

The coolant flowing from the coolant heater 70 along the sixth line 106 may pass through the chiller 25 while flowing along the fourth line 104 connected to the sixth line 106.

The air conditioner unit 20 may supply the refrigerant condensed in the condenser 21 to the chiller 25 through the third refrigerant line 26, in an expanded state.

Then, the low-temperature refrigerant may be introduced into the chiller 25 through the third refrigerant line 26.

The low-temperature refrigerant introduced into the chiller 25 may cool the coolant flowing along the fourth line 104 while heat-exchanging with the coolant introduced from the battery 50 through the sixth line 106 and the fourth line 104.

The coolant cooled in the chiller 25 may flow through the fourth line 104, and may be introduced into the control valve 100 through the fourth port P4.

The coolant introduced into the control valve 100 through the fourth port P4 may flow to the sixth port P6 by the control valve 100, thereby repeatedly performing above-described processes.

That is, the coolant cooled in the chiller 25 may be supplied to the battery 50 along the sixth line 106 connected to the sixth port P6 by the control valve 100. Accordingly, the battery 50 may be efficiently cooled by the coolant cooled in the chiller 25.

The air conditioner unit 20 may supply the refrigerant condensed in the condenser 21 to the evaporator 23 through the second refrigerant line 24, in an expanded state.

Accordingly, the low-temperature refrigerant may be supplied to the evaporator 23. Then, the air introduced into the HVAC module (not shown) may be cooled by the low-temperature refrigerant introduced into the evaporator 23 while passing through the evaporator 23.

The ambient air cooled while passing through the evaporator 23 may pass through the heater core 15 that is not supplied with the high-temperature coolant, to be introduced into the vehicle interior, thereby smoothly cooling the vehicle interior.

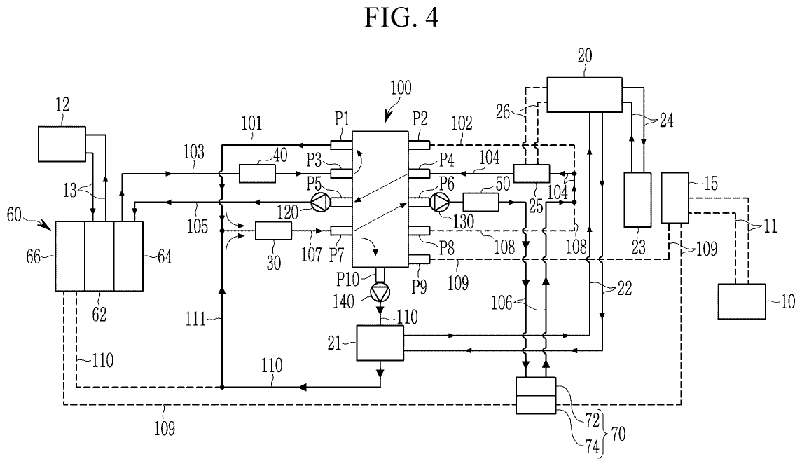

In an embodiment of the present disclosure, an operation in the third mode, for cooling the intercooler 12, the electrical component 40, and the battery 50 by using the coolant cooled in the radiator 30 while cooling the vehicle interior, and in which the engine 10 may be operated, will be described in detail with reference to FIG. 4.

FIG. 4 is an operation diagram according to the third mode in a heat pump system for a vehicle according to an embodiment of the present disclosure.

Referring to FIG. 4, in the third mode, in the heat pump system, the engine 10 may be operated, and the intercooler 12, the electrical component 40, and the battery 50 may be cooled by using the coolant cooled in the radiator 30, while cooling the vehicle interior.

To cool the vehicle interior, the air conditioner unit 20 may be operated. Accordingly, the first refrigerant line 22 may be opened so that the refrigerant is supplied from the air conditioner unit 20 to the condenser 21.

The second refrigerant line 24 may be opened so that the refrigerant is supplied from the air conditioner unit 20 to the evaporator 23.

The third refrigerant line 26 may be closed.

The first line 101, the third line 103, the fifth line 105, and the seventh line 107 may be opened by the control valve 100.

Simultaneously, the second line 102, the eighth line 108, and the ninth line 109 may be closed by the control valve 100.

The fourth line 104 and the sixth line 106 may be opened by the control valve 100.

A portion of the tenth line 110 connected to the second end of the eleventh line 111 and having a first end of the tenth line 110 connected to the control valve 100 may be opened by the control valve 100.

The remaining tenth line 110 connecting the second end of the eleventh line 111 to the heat-exchanger 60 may be closed.

Because the vehicle interior is to be cooled, the first connection line 11 connecting the engine 10 and the heater core 15 may be closed.

The second connection line 13 connecting the intercooler 12 and the heat-exchanger 60 may be opened. Accordingly, the coolant discharged in the intercooler 12 may be introduced into the first heat dissipating portion 62 of the heat-exchanger 60 along the second connection line 13.

The coolant introduced from the intercooler 12 into the first heat dissipating portion 62 may sequentially pass through the third heat dissipating portion 66 and the second heat dissipating portion 64 from the first heat dissipating portion 62, and then be introduced back into the intercooler 12.

In such mode, the first water pump 120, the second water pump 130, and the third water pump 140 each may be operated.

Then, the coolant flowing from the fifth port P5 of the control valve 100 along the fifth line 105 by the first water pump 120 may be introduced into the second heat dissipating portion 64 of the heat-exchanger 60.

The coolant having passed through the second heat dissipating portion 64 may pass through the electrical component 40 along the third line 103, and then be introduced into the control valve 100 through the third port P3.

The coolant introduced into the third port P3 may flow along the first line 101 connected to the first port P1 by the control valve 100.

The coolant flowing from the tenth port P10 of the control valve 100 along the opened portion of the tenth line 110 by the third water pump 140 may pass through the condenser 21.

In such mode, the condenser 21 may condense the refrigerant while heat-exchanging the refrigerant supplied through the first refrigerant line 22 with the coolant flowing along the tenth line 110.

The refrigerant condensed in the condenser 21 may be introduced into the air conditioner unit 20 along the first refrigerant line 22.

The coolant having passed through the condenser 21 may flow along the opened portion of the tenth line 110 and the eleventh line 111.

Accordingly, the coolant flowing through the first line 101 may flow to the seventh line 107 together with the coolant flowing through the eleventh line 111.

The coolant flowing through the seventh line 107 may be cooled through heat-exchange with the ambient air while passing through the radiator 30. Thereafter, the coolant cooled in the radiator 30 may be introduced into the control valve 100 through the seventh port P7.

The coolant introduced into the control valve 100 through the seventh port P7 may flow to the sixth port P6 by the control valve 100.

The coolant flowing from the seventh port P7 to the sixth port P6 by the control valve 100 may flow from the sixth port P6 of the control valve 100 along the sixth line 106 by the second water pump 130. The coolant flowing through the sixth line 106 may pass through the battery 50.

The coolant having passed through the battery 50 may pass through the first heater 72 of the coolant heater 70 along the sixth line 106. The coolant heater 70 is not operated.

The coolant flowing from the coolant heater 70 along the sixth line 106 may pass through the chiller 25 while flowing along the fourth line 104 connected to the sixth line 106.

Because the third refrigerant line 26 is closed, the refrigerant may not be supplied to the chiller 25. Accordingly, the coolant introduced into the chiller 25 may pass through the chiller 25 without heat-exchanging with the refrigerant.

The coolant having passed through the chiller 25 along the fourth line 104 may be introduced into the control valve 100 through the fourth port P4.

The coolant introduced into the control valve 100 through the fourth port P4 may flow to the fifth port P5 by the control valve 100, thereby repeatedly performing above-described processes.

While repeatedly performing such an operation, the coolant cooled in the radiator 30 may cool the electrical component 40 and the battery 50, and may condense the refrigerant supplied to the condenser 21.

The coolant cooled in the radiator 30 may first cool the battery 50 by the control valve 100, thereby cooing the battery 50 more efficiently.

The coolant cooled in the radiator 30 may cool the coolant supplied from the intercooler 12 through heat-exchange with the coolant introduced from the intercooler 12 into the first heat dissipating portion 62 and passing through the second heat dissipating portion 64, while passing through the second heat dissipating portion 64.

The coolant cooled in the heat-exchanger 60 may be discharged from the first heat dissipating portion 62 to the intercooler 12. Accordingly, the intercooler 12 may be efficiently cooled by the coolant cooled while passing through the heat-exchanger 60.

The air conditioner unit 20 may supply the refrigerant condensed in the condenser 21 to the evaporator 23 through the second refrigerant line 24, in an expanded state.

Accordingly, the low-temperature refrigerant may be supplied to the evaporator 23. Then, the air introduced into the HVAC module (not shown) may be cooled by the low-temperature refrigerant introduced into the evaporator 23 while passing through the evaporator 23.

The ambient air cooled while passing through the evaporator 23 may pass through the heater core 15 that is not supplied with the high-temperature coolant, to be introduced into the vehicle interior, thereby smoothly cooling the vehicle interior.

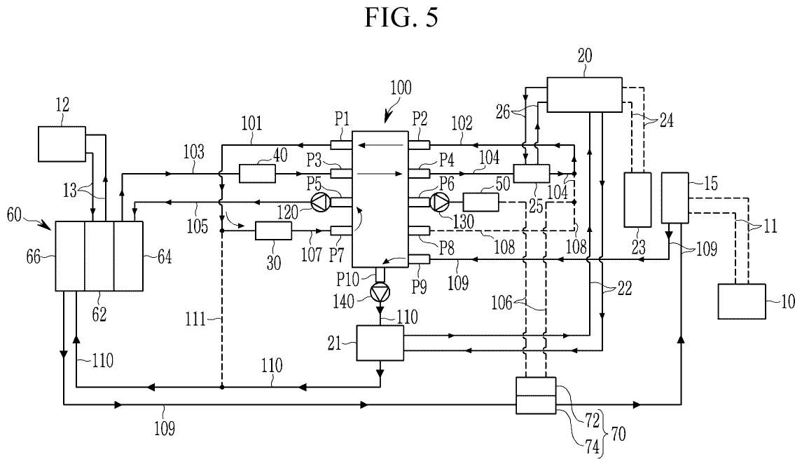

In an embodiment of the present disclosure, the engine 10 may be operated, and an operation in the fourth mode for heating the vehicle interior by using the thermal energy generated from the intercooler 12 will be described in detail with reference to FIG. 5.

FIG. 5 is an operation diagram according to the fourth mode in a heat pump system for a vehicle according to an embodiment of the present disclosure.

Referring to FIG. 5, in the fourth mode, in the heat pump system, the engine 10 may be operated, and the vehicle interior may be heated by using the thermal energy generated from the intercooler 12.

That is, in the fourth mode, when the thermal energy generated from the engine 10 is not sufficient before warming up of the engine 10, the vehicle interior may be heated by using the thermal energy generated from the intercooler 12.

The first line 101, the third line 103, the fifth line 105, and the seventh line 107 may be opened by the control valve 100.

Simultaneously, the second line 102 and the fourth line 104 may be opened by the control valve 100.

The sixth line 106 and the eighth line 108 may be closed by the control valve 100.

The ninth line 109 and the tenth line 110 may be opened by the control valve 100. The eleventh line 111 may be closed.

Because warming up of the engine is not completed and the thermal energy generated from the engine 10 is not sufficient, the first connection line 11 connecting the engine 10 and the heater core 15 may be closed.

The second connection line 13 connecting the intercooler 12 and the heat-exchanger 60 may be opened. Accordingly, the coolant discharged in the intercooler 12 may be introduced into the first heat dissipating portion 62 of the heat-exchanger 60 along the second connection line 13.

The coolant introduced from the intercooler 12 into the first heat dissipating portion 62 may sequentially pass through the third heat dissipating portion 66 and the second heat dissipating portion 64 from the first heat dissipating portion 62, and then be introduced back into the intercooler 12.

In such mode, the first water pump 120 and the third water pump 140 each may be operated.

Then, the coolant flowing from the fifth port P5 of the control valve 100 along the fifth line 105 by the first water pump 120 may be introduced into the second heat dissipating portion 64 of the heat-exchanger 60.

The coolant having passed through the second heat dissipating portion 64 may pass through the electrical component 40 along the third line 103, and then be introduced into the control valve 100 through the third port P3.

The coolant introduced into the third port P3 may flow along the fourth line 104 connected to the fourth port P4 by the control valve 100.

The coolant flowing through the fourth line 104 may pass through the chiller 25, and then flow along the opened second line 102. The coolant flowing through the second line 102 may be introduced into the control valve 100 through the second port P2.

Then, the coolant introduced into the second port P2 may flow along the first line 101 connected to the first port P1 by the control valve 100.

The coolant flowing through the first line 101 may flow to the seventh line 107. The coolant flowing through the seventh line 107 may be cooled through heat-exchange with the ambient air while passing through the radiator 30.

Then, the coolant cooled in the radiator 30 may be introduced into the control valve 100 through the seventh port P7.

The coolant introduced into the control valve 100 through the seventh port P7 may flow to the fifth port P5 by the control valve 100.

The coolant flowing from the tenth port P10 of the control valve 100 along the opened portion of the tenth line 110 by the third water pump 140 may pass through the condenser 21.

The coolant having passed through the condenser 21 may be introduced into the third heat dissipating portion 66 along the tenth line 110.

The coolant having passed through the third heat dissipating portion 66 may pass through the second heater 74 of the coolant heater 70 along the ninth line 109, to be then introduced into the heater core 15.

Then, the coolant having passed through the heater core 15 may be introduced into the ninth port P9 along the ninth line 109. The coolant introduced into the ninth port P9 may flow along the tenth line 110 connected to the tenth port P10 by the control valve 100.

While repeatedly performing such an operation, the coolant introduced into the third heat dissipating portion 66 through the tenth line 110 may cool the coolant supplied from the intercooler 12 through heat-exchange with the coolant introduced from the intercooler 12 to the first heat dissipating portion 62 and passing through the third heat dissipating portion 66, while passing through the third heat dissipating portion 66.

The coolant introduced into the third heat dissipating portion 66 may have an increased temperature by the thermal energy generated from the intercooler 12 while heat-exchanging with the coolant introduced from the intercooler 12.

The coolant heated while passing through the third heat dissipating portion 66 may be introduced into the heater core 15 along the ninth line 109.

The air introduced into the HVAC module (not shown) may be introduced at a room-temperature state that is not cooled, when it has passed through the evaporator 23 that is not supplied with the refrigerant. The introduced ambient air may be converted into a high-temperature state while passing through the heater core 15 and then introduced into the vehicle interior, thereby implementing heating of the vehicle interior.

The coolant cooled in the radiator 30 may additionally cool the coolant supplied from the intercooler 12 through heat-exchange with the coolant introduced from the intercooler 12 into the first heat dissipating portion 62 and passing through the second heat dissipating portion 64, while passing through the second heat dissipating portion 64.

Accordingly, the intercooler 12 may be more efficiently cooled by the coolant cooled by being heat-exchanged with the coolant introduced from the heater core 15 in the heat-exchanger 60, and by being additionally heat-exchanged with the coolant cooled from the radiator 30.

In the fourth mode, when the thermal energy generated from the intercooler 12 is not sufficient, the air conditioner unit 20 may be operated.

Then, the first refrigerant line 22 may be opened so that the refrigerant is supplied from the air conditioner unit 20 to the condenser 21. The third refrigerant line 26 may be opened so that the refrigerant is supplied from the air conditioner unit 20 to the chiller 25.

The second refrigerant line 24 may be closed, so that the refrigerant is not supplied from the air conditioner unit 20 to the evaporator 23.

Accordingly, the condenser 21 may condense the refrigerant while heat-exchanging the refrigerant supplied through the first refrigerant line 22 with the coolant flowing along the tenth line 110.

The chiller 25 may evaporate the refrigerant while heat-exchanging the refrigerant supplied through the third refrigerant line 26 with the coolant flowing along the fourth line 104.

The coolant supplied to the chiller 25 through the fourth line 104 may have its temperature increased by recollecting an ambient air heat and a waste heat of the electrical component 40 while passing through the radiator 30 and the electrical component 40. Therefore, the chiller 25 may smoothly evaporate the introduced refrigerant.

The coolant passing through the condenser 21 may have an increased temperature while heat-exchanging with a high-temperature refrigerant. The coolant heated in the condenser 21 may be introduced into the third heat dissipating portion 66 along the tenth line 110.

Accordingly, the coolant heated in the condenser 21 may have a further increased temperature by the thermal energy generated from the intercooler 12 while heat-exchanging with the coolant introduced from the intercooler 12 into the first heat dissipating portion 62 and passing through the third heat dissipating portion 66, the third heat dissipating portion 66.

The coolant of which the temperature is further increased in the heat-exchanger 60 may be introduced into the heater core 15 along the ninth line 109.

Therefore, the coolant of which the temperature is increased by recollecting heat from the thermal energy of the intercooler 12 and the refrigerant supplied from the condenser 21 is supplied to the heater core 15, thereby heating the vehicle interior more efficiently.

In an embodiment of the present disclosure, the second heater 74 of the coolant heater 70 may be operated when the temperature of the coolant flowing along the ninth line 109 is low.

That is, when the temperature of the coolant flowing along the ninth line 109 is lower than or equal to a predetermined temperature, the second heater 74 may be operated to increase the temperature of the coolant.

Accordingly, when the second heater 74 is operated, because the temperature of the coolant supplied to the heater core 15 may be rapidly increased, the vehicle interior may be rapidly heated.

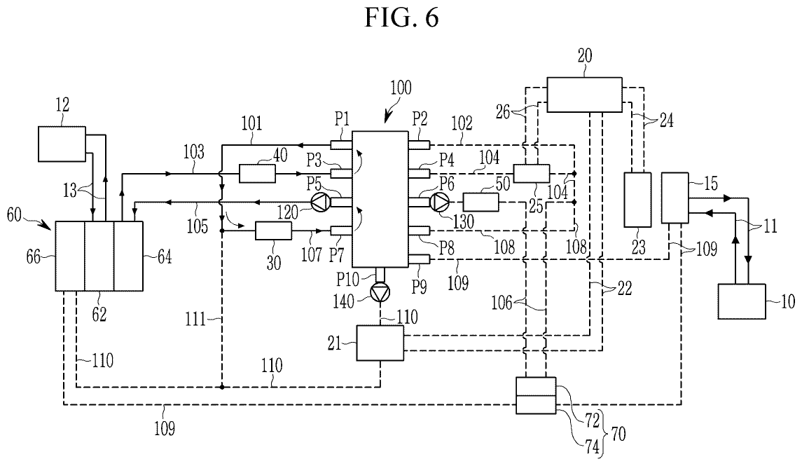

In an embodiment of the present disclosure, the engine 10 may be operated, and an operation in the fifth mode for heating the vehicle interior by using the thermal energy generated from the engine 10 will be described in detail with reference to FIG. 6.

FIG. 6 is an operation diagram according to the fifth mode in a heat pump system for a vehicle according to an embodiment of the present disclosure.

Referring to FIG. 5, in the fifth mode, in the heat pump system, the engine 10 may be operated, and the vehicle interior by using the thermal energy generated from the engine 10 may be heated.

That is, in the fifth mode, while warming up of the engine is completed and the engine is smoothly operated, the vehicle interior may be heated by using the thermal energy generated from the engine 10.

An operation of the air conditioner unit 20 may be stopped. Accordingly, the first refrigerant line 22, the second refrigerant line 24, and the third refrigerant line 26 may be closed.

In an embodiment of the present disclosure, the first line 101, the third line 103, the fifth line 105, and the seventh line 107 may be opened by the control valve 100.

Simultaneously, the second line 102, the fourth line 104, the sixth line 106, the eighth line 108, the ninth line 109, and the tenth line 110 may be closed by the control valve 100. The eleventh line 111 may be closed.

The first connection line 11 may be opened so that the coolant is supplied from the engine 10 to the heater core 15.

The second connection line 13 connecting the intercooler 12 and the heat-exchanger 60 may be opened. Accordingly, the coolant discharged in the intercooler 12 may be introduced into the first heat dissipating portion 62 of the heat-exchanger 60 along the second connection line 13.

The coolant introduced from the intercooler 12 into the first heat dissipating portion 62 may sequentially pass through the third heat dissipating portion 66 and the second heat dissipating portion 64 from the first heat dissipating portion 62, and then be introduced back into the intercooler 12.

In such mode, the first water pump 120 may be operated.

Then, the coolant flowing from the fifth port P5 of the control valve 100 along the fifth line 105 by the first water pump 120 may be introduced into the second heat dissipating portion 64 of the heat-exchanger 60.

The coolant having passed through the second heat dissipating portion 64 may pass through the electrical component 40 along the third line 103, and then be introduced into the control valve 100 through the third port P3.

The coolant introduced into the third port P3 may flow along the first line 101 connected to the first port P1 by the control valve 100. The coolant flowing through the first line 101 may flow to the seventh line 107.

The coolant flowing through the seventh line 107 may be cooled through heat-exchange with the ambient air while passing through the radiator 30. Thereafter, the coolant cooled in the radiator 30 may be introduced into the control valve 100 through the seventh port P7.

The coolant introduced into the control valve 100 through the seventh port P7 may flow to the fifth port P5 by the control valve 100.

While repeatedly performing such an operation, the coolant cooled in the radiator 30 may cool the electrical component 40.

The coolant cooled in the radiator 30 may cool the coolant supplied from the intercooler 12 through heat-exchange with the coolant introduced from the intercooler 12 into the first heat dissipating portion 62 and passing through the second heat dissipating portion 64, while passing through the second heat dissipating portion 64.

The coolant cooled in the heat-exchanger 60 may be discharged from the first heat dissipating portion 62 to the intercooler 12. Accordingly, the intercooler 12 may be efficiently cooled by the coolant cooled while passing through the heat-exchanger 60.

By the thermal energy generated from the engine 10 while cooling the engine 10, the coolant whose temperature is increased may be introduced into the heater core 15 through the first connection line 11.

Then, the coolant having passed through the heater core 15 may be supplied to the engine 10 again.

The air introduced into the HVAC module (not shown) may be introduced at a room-temperature state that is not cooled, when it has passed through the evaporator 23 that is not supplied with the refrigerant. The introduced ambient air may be converted into a high-temperature state while passing through the heater core 15 and then introduced into the vehicle interior, thereby implementing heating of the vehicle interior.

That is, in the fifth mode, the thermal energy generated from the engine 10 may be used for heating of the vehicle interior, and the intercooler 12 may be smoothly cooled by using the coolant cooled in the radiator 30.

As described above, according to a heat pump system for a vehicle according to an embodiment of the present disclosure, in an extended range electric vehicle (EREV) applied with the engine 10 for charging of the battery 50, the flowing movement of the coolant may be control by using the single control valve 100 depending on at least one mode for adjusting the temperature of the vehicle interior and for adjusting the temperature of the battery 50, thereby achieving streamlining of the entire system.

According to an embodiment of the present disclosure, by adjusting the temperature of the vehicle interior and by efficiently controlling the temperature of the battery 50 by selectively using the thermal energy generated from the engine 10 and the intercooler 12, the usage of the electric heater at the time of heating of the vehicle interior can be minimized, so that the power consumption amount may be reduced, and the overall marketability may be improved.

According to an embodiment of the present disclosure, the heating efficiency may be improved by selectively using the thermal energy of the engine 10 or the intercooler 12 at the time of heating of the vehicle interior, and by efficiently adjusting the temperature of the battery 50 so that the optimal performance of the battery 50 can be achieved, the overall travel distance of the vehicle may be increased.

According to an embodiment of the present disclosure, due to streamlining of the entire system, it is possible to reduce the overall manufacturing cost and weight, and improve space utilization by minimizing the number of components.

While the present disclosure has been described in connection with what is presently considered to be practical example embodiments, it can be understood that the present disclosure is not necessarily limited to the disclosed example embodiments. On the contrary, the present disclosure can cover various modifications and equivalent arrangements included within the spirit and scopes of the appended claims.

What is claimed is:

1. A heat pump system comprising:
a control valve including a plurality of ports, wherein the control valve is configured to control a flowing movement of a coolant depending on at least one mode for adjusting a vehicle-interior temperature of a vehicle interior or for adjusting a battery temperature of a battery;
a heat-exchanger comprising at least one heat dissipating portion configured to heat-exchange the coolant of the at least one heat dissipating portion with each other;
a first line having a first-line first end connected to the control valve to allow the coolant to selectively flow via the first line;
a second line having a second-line first end connected to the control valve to allow the coolant to selectively flow via the second line;
a third line having a third-line first end connected to the control valve to selectively allow the coolant to flow via the third line, wherein the third line has a third-line second end connected to the heat-exchanger, and wherein the third line is configured to flow the coolant through an electrical component;
a fourth line having a fourth-line first end connected to the control valve to allow the coolant to selectively flow via the fourth line, and wherein the fourth line is configured to flow the coolant through a chiller;
a fifth line having a fifth-line first end connected to the control valve, and a fifth-line second end connected to the heat-exchanger, and wherein the fifth line is configured to flow the coolant;
a sixth line having a sixth-line first end connected to the control valve to allow the coolant to selectively flow via the sixth line, and wherein the sixth line is configured to flow the coolant through the battery;
a seventh line having a seventh-line first end connected to the control valve to allow the coolant to selectively flow via the seventh line, and wherein the seventh line is configured to flow the coolant through a radiator;
an eighth line having an eighth-line first end connected to the control valve to allow the coolant to selectively flow via the eighth line;
a ninth line having a ninth-line first end connected to the control valve to allow the coolant to selectively flow via the ninth line, having a ninth-line second end connected to the heat-exchanger, and wherein the ninth line is configured to flow the coolant through a heater core;
a tenth line having a tenth-line first end connected to the control valve to allow the coolant to selectively flow via the tenth line, having a tenth-line second end connected to the heat-exchanger, and wherein the tenth line is configured to flow the coolant through a condenser;
a first connection line configured to connect the heater core to an engine, and wherein the first connection line is configured to flow the coolant;
a second connection line configured to connect the heat-exchanger to an intercooler, and wherein the second connection line is configured to flow the coolant; and
at least one water pump at the control valve and configured to flow the coolant through at least one line of the first to the tenth lines.

2. The system of claim 1, wherein a first-line second end of the first line is connected to a seventh-line second end of the seventh line;
wherein a second-line second end of the second line is connected to the fourth line at a first junction, wherein the first junction is on the fourth line where the fourth line is configured to be connected between the chiller and a fourth-line second end of the fourth line;
wherein the fourth-line second end of the fourth line and an eighth-line second end of the eighth line are respectively connected a sixth-line second end of the sixth line; and
wherein the seventh-line second end of the seventh line is connected to the first-line second end of the first line.

3. The system of claim 1, further comprising an eleventh line having an eleventh-line first end connected to a first-line second end of the first line and a seventh-line second end of the seventh line, and wherein the eleventh line has an eleventh-line second end connected to the tenth line at a first junction, wherein the first junction is on the tenth line where the tenth line is configured to be connected between the condenser and the heat-exchanger.

4. The system of claim 3, further comprising an air conditioner device through which a refrigerant circulates,
wherein the air conditioner device comprises:
a first refrigerant line connecting the air conditioner device and the condenser, and configured so that the refrigerant can be supplied to the condenser;
a second refrigerant line;
an evaporator on the second refrigerant line, wherein the second refrigerant line is configured to flow the refrigerant through the evaporator; and
a third refrigerant line connecting the air conditioner device and the chiller, and configured so that the refrigerant can be supplied to the chiller.

5. The system of claim 4, wherein the at least one mode comprises:
a first mode for cooling the electrical component by using the coolant cooled in the radiator while cooling the vehicle interior, and in which the engine is not operated;
a second mode for cooling the battery by using the coolant heat-exchanged with the refrigerant, while cooling the vehicle interior, and for cooling the intercooler and the electrical component by using the coolant cooled in the radiator, and in which the engine is operated;
a third mode for cooling the intercooler, the electrical component, and the battery by using the coolant cooled in the radiator while cooling the vehicle interior and in which the engine is operated;
a fourth mode for heating the vehicle interior by using a first thermal energy generated from the intercooler and in which the engine is operated; and
a fifth mode for heating the vehicle interior by using a second thermal energy generated from the engine and in which the engine is operated.

6. The system of claim 5, wherein, in the first mode, the system is configured such that:
the first line, the third line, the fifth line, and the seventh line are opened by the control valve;
the second line, the fourth line, the sixth line, the eighth line, and the ninth line are closed by the control valve;
a first portion of the tenth line connected to the eleventh-line second end of the eleventh line and having the tenth-line first end connected to the control valve is opened by the control valve;
a remaining second portion of the tenth line connecting the eleventh-line second end of the eleventh line to the heat-exchanger is closed;
the first connection line and the second connection line are closed;
the first refrigerant line is opened so that the refrigerant is supplied from the air conditioner device to the condenser;
the second refrigerant line is opened so that the refrigerant is supplied from the air conditioner device to the evaporator; and
the third refrigerant line is closed.

7. The system of claim 5, wherein, in the second mode, the system is configured such that:
the first line, the third line, the fifth line, and the seventh line are opened by the control valve;
the second line, the eighth line, and the ninth line are closed by the control valve;
the fourth line and the sixth line are opened by the control valve;
a first portion of the tenth line connected to the eleventh-line second end of the eleventh line and having the tenth-line first end connected to the control valve is opened by the control valve;
a remaining second portion of the tenth line connecting the eleventh-line second end of the eleventh line to the heat-exchanger is closed;
the first connection line is closed;
the second connection line connecting the intercooler and the heat-exchanger is opened;
the first refrigerant line is opened so that the refrigerant is supplied from the air conditioner device to the condenser;
the second refrigerant line is opened so that the refrigerant is supplied from the air conditioner device to the evaporator; and
the third refrigerant line is opened, so that the refrigerant is supplied from the air conditioner device to the chiller.

8. The system of claim 5, wherein, in the third mode, the system is configured such that:
the first line, the third line, the fifth line, and the seventh line are opened by the control valve;
the second line, the eighth line, and the ninth line are closed by the control valve;
the fourth line and the sixth line are opened by the control valve;
a first portion of the tenth line connected to the eleventh-line second end of the eleventh line and having the tenth-line first end connected to the control valve is opened by the control valve;
a remaining second portion of the tenth line connecting the eleventh-line second end of the eleventh line to the heat-exchanger is closed;
the first connection line is closed;
the second connection line connecting the intercooler and the heat-exchanger is opened;
the first refrigerant line is opened so that the refrigerant is supplied from the air conditioner device to the condenser;
the second refrigerant line is opened so that the refrigerant is supplied from the air conditioner device to the evaporator; and
the third refrigerant line is closed.

9. The system of claim 5, wherein, in the fourth mode, the system is configured such that:
the first line, the third line, the fifth line, and the seventh line are opened by the control valve;
the second line and the fourth line are opened by the control valve;
the sixth line and the eighth line are closed by the control valve;
the ninth line and the tenth line are opened by the control valve;
the eleventh line is closed;
the first connection line is closed; and
the second connection line connecting the intercooler and the heat-exchanger is opened.

10. The system of claim 9, wherein, based on the first thermal energy generated from the intercooler being not sufficient in the fourth mode, the system is configured such that:
the first refrigerant line is opened so that the refrigerant is supplied from the air conditioner device to the condenser;
the second refrigerant line is closed; and
the third refrigerant line is opened, so that the refrigerant is supplied from the air conditioner device to the chiller.

11. The system of claim 5, wherein, in the fifth mode, the system is configured such that:
the first line, the third line, the fifth line, and the seventh line are opened by the control valve;
the second line, the fourth line, the sixth line, the eighth line, the ninth line, and the tenth line are closed by the control valve;
the eleventh line is closed;
the first connection line is opened so that the coolant is supplied from the engine to the heater core;
the second connection line connecting the intercooler and the heat-exchanger is opened; and
the first refrigerant line, the second refrigerant line, and the third refrigerant line are closed.

12. The system of claim 1, wherein the control valve comprises:
a first port connected to the first-line first end of the first line;
a second port connected to the second-line first end of the second line;
a third port connected to the third-line first end of the third line; and
a fourth port connected to the fourth-line first end of the fourth line.

13. The system of claim 12, wherein the control valve comprises:
a fifth port connected to the fifth-line first end of the fifth line;
a sixth port connected to the sixth-line first end of the sixth line;
a seventh port connected to the seventh-line first end of the seventh line;
an eighth port connected to the eighth-line first end of the eighth line;
a ninth port connected to the ninth-line first end of the ninth line; and
a tenth port connected to the tenth-line first end of the tenth line.

14. The system of claim 13, wherein the at least one water pump comprises:
a first water pump at the fifth port;
a second water pump at the sixth port; and
a third water pump at the tenth port.

15. The system of claim 1, wherein the at least one heat dissipating portion comprises:
a first heat dissipating portion connected to the intercooler through the second connection line;
a second heat dissipating portion provided on a first-heat-dissipating-portion first side of the first heat dissipating portion, and connected to the third line and the fifth line; and
a third heat dissipating portion provided on a first-heat-dissipating-portion second side of the first heat dissipating portion, and connected to the ninth line and the tenth line.

16. The system of claim 15, wherein the at least one heat dissipating portion is configured such that the coolant introduced from the intercooler into the first heat dissipating portion through a second coolant line respectively passes through the second heat dissipating portion and the third heat dissipating portion, and then is discharged to the intercooler through the first heat dissipating portion again.

17. The system of claim 15, wherein the at least one heat dissipating portion is configured such that the coolant introduced into each of the first heat dissipating portion, the second heat dissipating portion, and the third heat dissipating portion are prevented from mixing with each other within the at least one heat dissipating portion.

18. The system of claim 15, wherein the at least one heat dissipating portion is configured such that the coolant introduced from the intercooler into the first heat dissipating portion is heat-exchanged with at least one of the coolant introduced into the second heat dissipating portion through the fifth line, or the coolant introduced into the third heat dissipating portion through the tenth line.

19. The system of claim 1, further comprising a coolant heater on the sixth line and the ninth line.

20. The system of claim 19, wherein the coolant heater comprises:
a first heater on the sixth line; and
a second heater on the ninth line.
